(19) United States
(12) Patent Application Publication
(10) Pub. No.: US 2006/0075363 A1
(43) Pub. Date: Apr. 6, 2006

(54) Information processing system, and program and recording medium implementing functions of the system

(75) Inventor: Yoshihiro Mizoguchi, Yamato-Kohriyama-shi (JP)

Correspondence Address: EDWARDS & ANGELL, LLP, P.O. BOX 55874, BOSTON, MA, 02205, US

(73) Assignee: Sharp Kabushiki Kaisha, Osaka-shi (JP)

(21) Appl. No.: 11/238,706

(22) Filed: Sep. 28, 2005

(30) Foreign Application Priority Data
Sep. 29, 2004 (JP) 2004-284294

(51) Int. Cl. G06F 3/00

(52) U.S. Cl. 715/863

(57) ABSTRACT

A user is enabled to easily set processing conditions with simple operations of a pointing device, such as a mouse. When a gesture operation operating a pointer being dragged corresponds to a predetermined operation retained in advance, an information processing device sets processing condition defined in advance correspondingly to the corresponding predetermined operation. For example, a user performs the gesture operation of the pointer on a print setting screen of a figure with the use of the pointing device, such as a mouse. The trace of the pointer is a predetermined operation defined in advance for setting the sheet direction to be horizontal, for example. A graphical user interface processing unit of the information processing system determines that the pointer operation is the horizontal sheet setting and sets the sheet direction to be horizontal in the print processing conditions.

### CROSS-NOTING PARAGRAPH

This non-provisional application claims priority under 35 U.S.C. §119(a) on Patent Application No. 2004-284294 filed in JAPAN on Sep. 29, 2004, the entire contents of which are hereby incorporated herein by reference.

### FIELD OF THE INVENTION

The present invention relates to an information processing system and a program and recording medium implementing functions of the system and, more particularly, to an information processing technology performing predetermined processing relevant to condition setting of information processing depending on operations of a pointing device.

### BACKGROUND OF THE INVENTION

In information processing apparatuses such as personal computers or portable information equipment, a method is widely used, which provides a so-called graphical user interface configured to collectively display icons on a screen of a display apparatus connected to or built into the information processing apparatuses for performing basic operations such as execution of programs and file processing, such that a user interactively operates the information processing apparatus.

Also, in the graphical user interface, an operation method or a user interface is known, which performs information processing using a file or changes a storage location of a file by dragging an icon representing the file displayed on a display screen to, for example, an icon representing an execution program for processing the file or an icon representing a group of files, with the use of a pointing device for input, such as a mouse.

For example, Japanese Laid-Open Patent Publication No. 2000-227828 discloses an information processing system which can change contents of processing before a dragged file icon is dropped onto an icon representing a start-up program, a group of icons, a printer or the like when forcing the information processing system to perform predetermined processing. In this disclosure, before dropping a target icon onto a start-up program to execute information processing, the processing conditions of the information processing can be set by moving the target icon to predetermined direction or stopping the icon for a predetermined period of time while dragging the icon in the vicinity of the start-up icon with a mouse.

However, although the information processing system of Japanese Laid-Open Patent Publication No. 2000-227828 discloses a configuration enabling to set the processing conditions of the information processing if the file icon is operated by drag and drop, nothing is disclosed about setting of the processing conditions in the case that the icon operation is not performed, such as the case that printing conditions are set by opening a printing screen from an application, for example.

For example, in the setting of the print processing conditions, a user must open a setting screen to set target condition items in sequence, and in conventional technologies, for such setting of the processing conditions, a technology has not been proposed for enabling to conveniently execute condition setting with the use of a pointer, such as a mouse.

### SUMMARY OF THE INVENTION

The object of the present invention is to enable a user to easily execute setting of processing conditions with simple operations of a pointing device such as a mouse on a screen for setting processing conditions, such as a regular application and thereby to provide an information processing system, program and recording medium which are highly convenient for the user.

Another object of the present invention is to provide an information processing system enabling connection between display means and a pointing device which can operate a pointer displayed on the display means, generating a user interface screen for setting a plurality of processing conditions relevant to information processing and displaying the user interface screen on the display means, and enabling a pointer displayed on the user interface screen to be operated by the pointing device, wherein when a gesture operation operating the pointer being dragged is performed and when the gesture operation corresponds to a predetermined operation retained in advance, the information processing system sets the processing condition defined in advance correspondingly to the corresponding predetermined operation.

It is yet another object of the present invention to provide the information processing system comprising: UI display means which generate a user interface to be displayed on the display means; a gesture operation information retaining means which retain setting information of processing conditions corresponding to the gesture operations of the pointer in advance; pointer operation detecting means which detect the gesture operations of the pointer displayed on the user interface screen; gesture operation determining means which refer to the gesture operation information retaining means according to the detection result of the pointer operation detecting means to determine setting information corresponding to the pointer gesture operation; processing condition setting means which set processing conditions according to the determination result of the gesture operation determining means; and setting information storage means which store the setting information of the processing conditions set by the processing condition setting means.

It is yet another object of the present invention to provide the information processing system, wherein the predetermined operation of the pointer comprises any one or more of motions of the pointer, which include movement in the upward, downward, leftward and rightward directions, diagonal movement, circle or circular arc movement, and stoppage for a predetermined time period.

It is yet another object of the present invention to provide the information processing system, wherein the setting can be performed for the processing condition corresponding to the predetermined operation of the pointer even if the processing condition to be set is not displayed on the user interface screen.

It is yet another object of the present invention to provide the information processing system, wherein if the setting corresponding to the predetermined operation is performed for the processing condition which is not displayed on the user interface screen, contents of the set processing condition may be displayed on the user interface screen.

It is yet another object of the present invention to provide the information processing system, wherein the information processing system is an information processing system which comprises a print data processing unit executing print data processing for performing print control of a printing apparatus connected to the information processing system and which acts as a printer driver controlling the printing apparatus with the use of the processing result of the print data processing unit; and processing conditions of the information processing may be conditions relevant to setting of print processing.

It is yet another object of the present invention to provide the information processing system, wherein print image information representing a print image is displayed on the user interface screen; and when the predetermined operation of the pointer is performed within the display area of the print image information, setting may be performed for the processing condition defined in advance correspondingly to the predetermined operation.

It is yet another object of the present invention to provide the information processing system, wherein a processing condition set by the predetermined operation can be restored to the processing condition before the setting by the operation of the pointing device or other input means.

It is yet another object of the present invention to provide a program operable to allow a computer to act as the above mentioned information processing system.

It is yet another object of the present invention to provide a computer-readable recording medium having the above mentioned program recorded thereon.

### BRIEF DESCRIPTION OF THE DRAWINGS

FIG. 1 is a view showing a configuration example of the information processing system of the present invention;

FIG. 2 is a view for describing an embodiment of the information processing system of the present invention;

FIG. 3 is a view for describing another embodiment of the information processing system of the present invention;

FIG. 4 is a flowchart for describing an example of processing at the time of a pointer operation in the image processing apparatus of the present invention;

FIG. 5A to FIG. 5I are views showing examples of predetermined pointer operations of gesture operations and setting conditions defined correspondingly to the gesture operations;

FIG. 6 is a view showing a configuration example of a gesture operation table which sets motions of FIG. 5A to FIG. 5I;

FIG. 7A and FIG. 7B are views for describing an example of the gesture operations in a print setting screen; and

FIG. 8 is a view for describing another example of the gesture operation in the print setting screen.

### PREFERRED EMBODIMENTS OF THE INVENTION

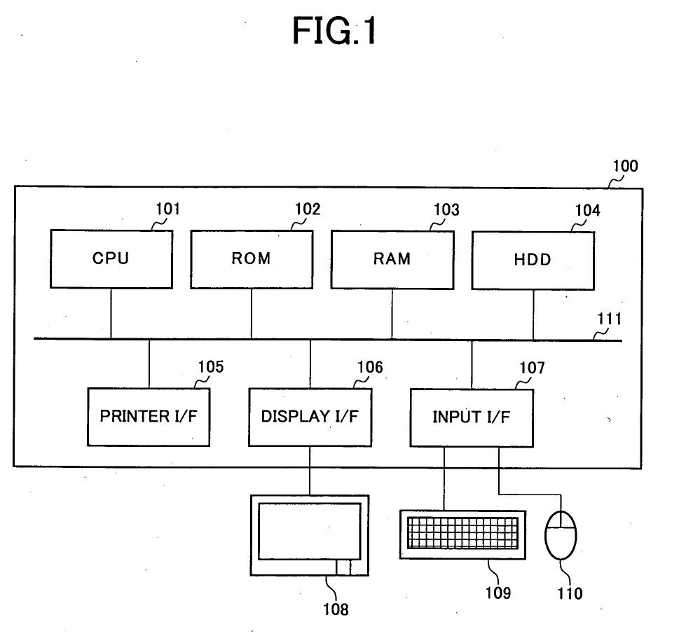

FIG. 1 is a view showing a configuration example of the information processing system of the present invention. The information processing system of this example can be implemented by a general-purpose computer apparatus. In the example of FIG. 1, the information processing system controls each element of the system and is connected via a bus 111 to: a CPU 101 executing a program achieving functions of the information processing according to the present invention; a ROM 102, RAM 103 and HDD 104 providing storage areas for various data and programs; a printer I/F 105 constituting an interface with a printer; a display I/F 106 for connecting a display apparatus 108 such as a CRT or LCD; and an input I/F for connecting a keyboard 109 and mouse 110 inputting various pieces of information.

The program achieving the functions of the present invention is stored in the HDD 104 or ROM 102 and is read by the CPU 101 to be executed with the use of the RAM 103. The program is provided with a graphical user interface (GUI) which is an interface with a user when the user uses the information processing apparatus, and the CPU 101 displays the GUI on the display apparatus 108 via the display I/F 106.

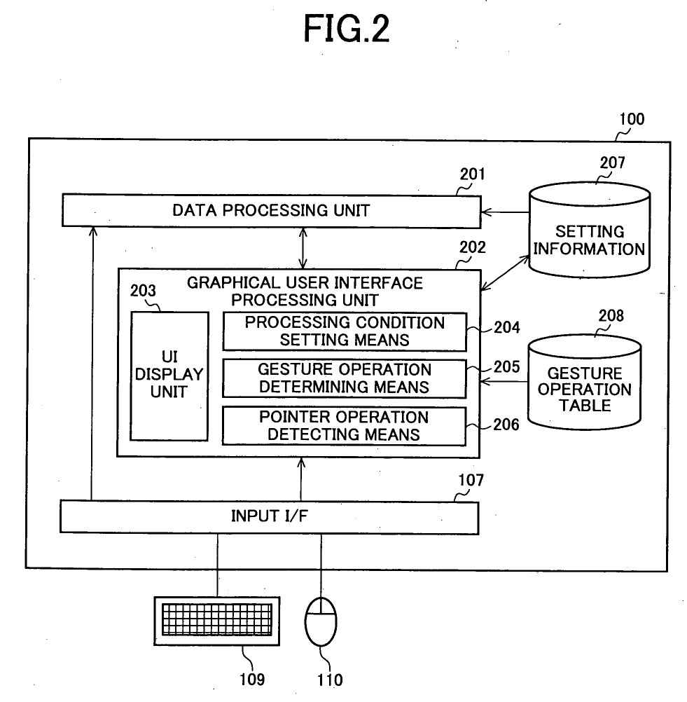

FIG. 2 is a view for describing an embodiment of the information processing system of the present invention. The information processing system is connected to the mouse 110, which is a pointing device, and the keyboard 109. The user interface is displayed on a display which is not shown.

When a predetermined operation is performed with the mouse 110 during dragging a pointer displayed on the display, the information processing apparatus 100 performs setting of a processing condition defined in advance correspondingly to the predetermined operation. These operations during dragging the pointer are referred to as gesture operations.

The above predetermined pointer operations may be operations defined in advance such as movement of the pointer in the upward, downward, leftward and rightward directions, diagonal movement, movement drawing a circle or a circular arc, and stopping for a predetermined time period, or may be a combination thereof. Specific examples of the predetermined operations are described later.

The information processing apparatus 100 has: a UI display unit 203 which generates a user interface to be displayed on the display; a gesture operation table 208 which retains setting information of processing conditions corresponding to the gesture operations of the pointer in advance; pointer operation detecting means 206 which detect the gesture operations of the pointer displayed on a user interface screen; gesture operation determining means 205 which refer to the gesture operation table 208 in accordance with the detection result of the pointer operation detecting means 206 to determine setting information corresponding to the pointer operation; processing condition setting means 204 which set processing conditions in accordance with the determination of the gesture operation determining means 205; and setting information storage means 207 which store the setting information of the processing conditions set by the processing condition setting means 204.

The graphical user interface processing unit 202 is constituted by the UI display unit 203, the processing condition setting means 204, the gesture operation determining means 205 and the pointer operation detecting means 206. The gesture operation table 208 corresponds to gesture operation information retaining means of the present invention, which retains the setting information of the processing conditions corresponding to the pointer gesture operations.

The above example is described as a behavior in accordance with user's operations. The UI display unit 203 of the graphical user interface processing unit 202 generates a user interface screen to be displayed on the display. The user uses the user interface screen displayed on the display and operates a pointing device, which is the mouse 110, to perform condition setting relevant to certain information processing (e.g., control processing of a printer, as described later).

In this case, the user uses the pointing device to operate the pointer displayed on the user interface screen. When doing this, predetermined operations are defined in advance for the gesture operation performed while dragging the pointer, and the gesture operation table 208 stores setting conditions corresponding to the predetermined operations. The user has the awareness of the predetermined operations and the setting conditions determined in accordance with the predetermined operations, and the user performs the predetermined operation corresponding to the desired setting condition with the pointer.

The pointer gesture operation performed by the user is detected by the pointer operation detecting means 206. Then, the gesture operation determining means 205 refer to the gesture operation table 208 and determine whether or not the pointer gesture operation detected by the pointer operation detecting means 206 is the predetermined operation retained in the gesture operation table 208. If corresponding to the predetermined operation, the condition setting information defined correspondingly to the predetermined operation is read out.

The motion of the pointer due to the gesture operation at this point is recognized as a moving distance between XY coordinates of the pointer. In other words, the pointer operation detecting means 206 detect data of an amount and a direction of the pointer movement, and the gesture operation determining means 205 read out relevant condition setting information from the detected data.

The processing condition setting means 204 perform the setting of the processing condition with the use of the read condition setting information and store the setting information of the set processing condition into the setting information storage means 207. A data processing unit 201 performs data processing based on the setting information changed by the processing condition setting means 204.

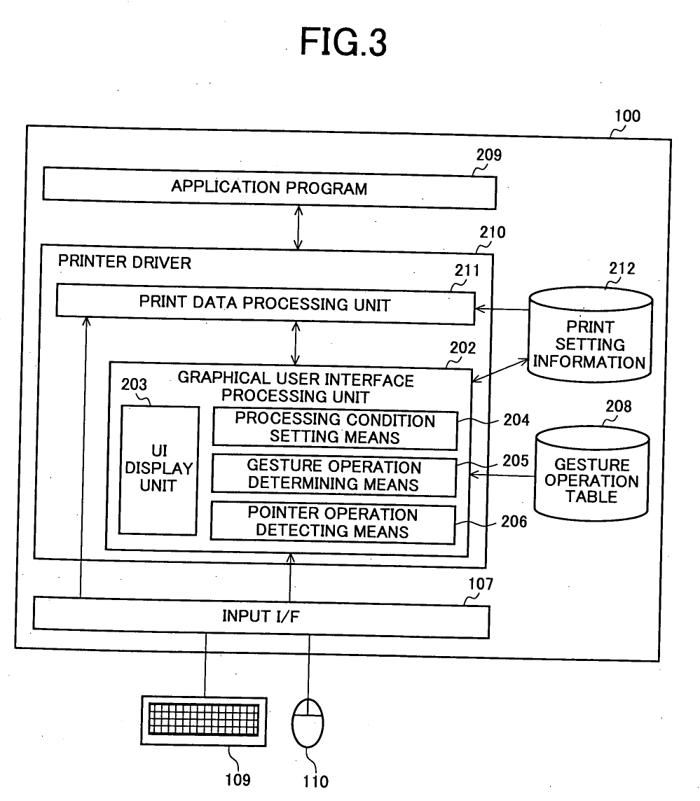

FIG. 3 is a view for describing another embodiment of the information processing system of the present invention. The information processing system of the present embodiment is an information processing system which has a print data processing unit 211 executing print data processing for performing print control of a printing apparatus and which acts as a printer driver controlling the printing apparatus with the use of the processing result of the print data processing unit 211. In this case, the processing conditions of the information processing defined correspondingly to the pointer gesture operations will be conditions relevant to setting of print processing.

The information processing system is connected to a mouse 110 as the pointing device, and a keyboard 109. A user interface is displayed on a display which is not shown. When a predetermined gesture operation is performed with the mouse 110 during dragging a pointer displayed on the display, the information processing apparatus 100 performs setting of a print processing condition defined in advance correspondingly to the predetermined gesture operation.

The information processing apparatus 100 has:. the UI display unit 203 which generates a user interface to be displayed on the display; the gesture operation table 208 which retains setting information of processing conditions corresponding to the gesture operations of the pointer in advance; the pointer operation detecting means 206 which detect the gesture operations of the pointer displayed on a user interface screen; the gesture operation determining means 205 which refer to the gesture operation table 208 in accordance with the detection result of the pointer operation detecting means 206 to determine setting information corresponding to the pointer operation; the processing condition setting means 204 which set processing conditions in accordance with the determination of the gesture operation determining means 205; and print setting information storage means 212 which store the setting information of the processing conditions set by the processing condition setting means 204.

The graphical user interface processing unit 202 is constituted by the UI display unit 203, the processing condition setting means 204, the gesture operation determining means 205 and the pointer operation detecting means 206. The gesture operation table 208 corresponds to the gesture operation information retaining means of the present invention, which retains the setting information of the processing conditions corresponding to the pointer gesture operations.

A printer driver 210 is comprised of the above graphical user interface processing unit 202 and the print data processing unit 211, and the print control operation of the printer driver 210 is initiated by a calling operation from the application program 209. The application program 209 refers to various application programs, such as word processor, spreadsheet and graphic programs, for example.

The above example is described as a behavior in accordance with user's operations. The UI display unit 203 of the graphical user interface processing unit 202 generates a user interface screen to be displayed on the display. The user uses the user interface screen displayed on the display and operates a pointing device, which is the mouse 110, to perform condition setting relevant to the control processing of the printer.

In this case, the user uses the pointing device to operate the pointer displayed on the user interface screen. When doing this, predetermined operations are defined in advance for the gesture operation performed while dragging the pointer, and the gesture operation table 208 stores print setting conditions corresponding to the predetermined operations. The user has the awareness of the predetermined operations and the print setting conditions determined in accordance with the predetermined operations, and the user performs the predetermined operation corresponding to the desired print setting condition with the pointer.

The pointer gesture operation performed by the user is detected by the pointer operation detecting means 206, and the gesture operation determining means 205 refer to the gesture operation table 208 and determine whether or not the detected pointer gesture operation is the predetermined operation retained in the gesture operation table 208, in order to read out the print condition setting information defined correspondingly to the predetermined operation. The processing condition setting means 204 perform the setting of the print processing condition with the use of the read print condition setting information and store the setting information of the set print processing condition into the print setting information storage means 212. The print data processing unit 211 performs data processing based on the setting information changed by the processing condition setting means 204 to achieve the print control processing function of the printer driver 210.

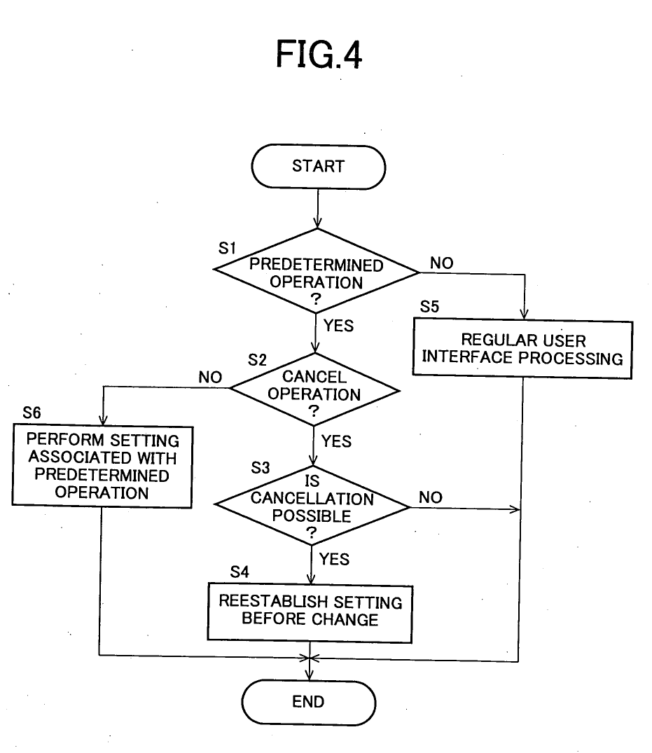

FIG. 4 is a flowchart for describing an example of processing at the time of a pointer operation in the image processing apparatus of the present invention.

When operating the pointer displayed on display means of the image processing apparatus, it is determined whether or not the operation corresponds to a predetermined operation (gesture operation) defined in advance (step S1). If the operation is not the predetermined operation, regular interface processing is executed (step S5).

The regular interface processing refers to, for example, processing for changing the setting by inputting characters in a text box, by selecting an item from a drop-down list or by changing a status with a click of a check box or radio button.

If it is determined that the pointer operation corresponds to the predetermined operation defined in advance in above step S1, it is determined whether the operation is a cancel operation of the last operation or not (step S2), and if the operation is not the cancel operation, setting is performed for the processing condition associated with the predetermined operation (step S6). In other words, the processing condition defined in advance is set according to the predetermined operation performed to the pointer.

In above step S2, if the operation is the cancel operation of the last operation, it is determined whether cancellation can be performed by the operation or not (step S3). The case in which the cancellation cannot be performed refers to the case that, for example, cancellation cannot be performed for setting relevant to specifications which cannot be restored to the previous operation after saving once, such as saving of user setting or changing and saving of a Watermark. In such a case, the cancel operation is invalidated in step S3 and the processing is terminated.

If the operation can be cancelled in above step S3, the setting before the change is reestablished (step S4) and the processing is terminated.

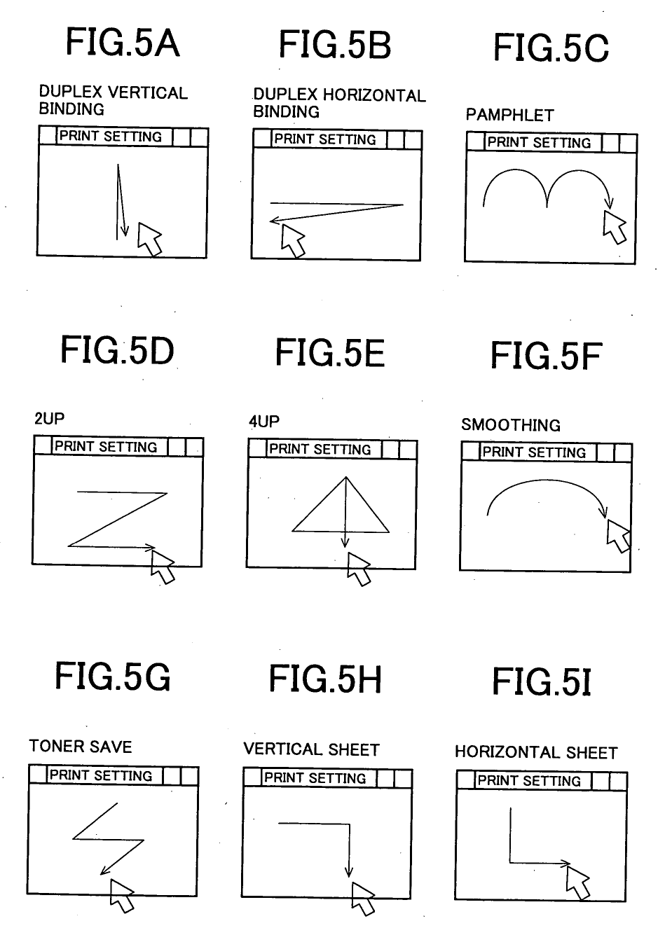

FIG. 5A to FIG. 5I are views showing examples of predetermined pointer operations of gesture operations and setting conditions defined correspondingly to the gesture operations, and FIG. 5A to FIG. 5I respectively show examples of traces of the pointer operations on the display screen and contents of the setting of the processing conditions thereof. In these figures, examples of the setting of the print processing conditions are shown for the case that the information processing system acts as a printer driver.

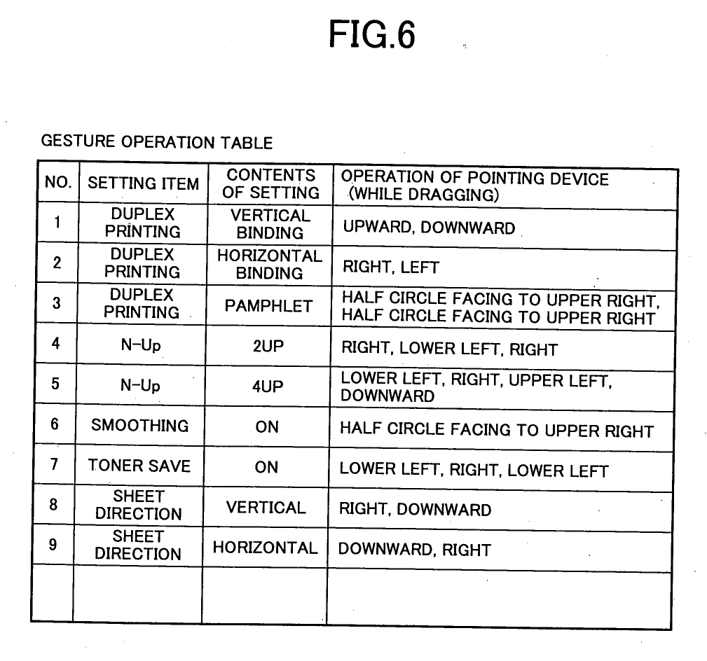

FIG. 6 is a view showing a configuration example of a gesture operation table which sets motions of FIG. 5A to FIG. 5I. The numbers 1 to 9 of FIG. 6 corresponds to the operations of FIG. 5A to FIG. 5I, respectively in sequence.

FIG. 5A is a setting example of duplex vertical-binding printing, and this gesture operation is an operation moving the pointer in the upward and downward directions on the screen.

FIG. 5B is a setting example of duplex horizontal-binding printing, and this gesture operation is an operation moving the pointer in the right and left directions on the screen.

FIG. 5C is a setting example of pamphlet printing, and this gesture operation is an operation moving the pointer on the screen such that two half circles facing to the upper right are sequentially drawn.

FIG. 5D is a setting example of 2UP (printing two pages on one sheet), and this gesture operation is an operation moving the pointer in the right, lower left and right directions on the screen.

FIG. 5E is a setting example of 4UP (printing four pages on one sheet), and this gesture operation is an operation moving the pointer in the lower left, right, upper left and downward directions on the screen.

FIG. 5F is a setting example of smoothing printing, and this gesture operation is an operation moving the pointer on the screen such that a half circle facing to the upper right is drawn.

FIG. 5G is a setting example of toner-save printing, and this gesture operation is an operation moving the pointer in the lower left, right and lower left directions on the screen.

FIG. 5H is a setting example of vertical-sheet printing, and this gesture operation is an operation moving the pointer in the right and downward directions on the screen.

FIG. 5I is a setting example of horizontal-sheet printing, and this gesture operation is an operation moving the pointer in the downward and right directions on the screen.

By performing the gesture operations of the pointer on the screen with the use of the pointing device, such as the mouse, in accordance with the predetermined operations defined in the respective setting examples as above, the user can easily set the print processing conditions corresponding to the operations. The above description shows the setting examples of the gesture operations, and the predetermined operations are not limited to these operations and can be set arbitrary by appropriately combining the movement in the upward, downward, left and right directions, diagonal movement, circle or circular arc movement, and stoppage for a predetermined time period.

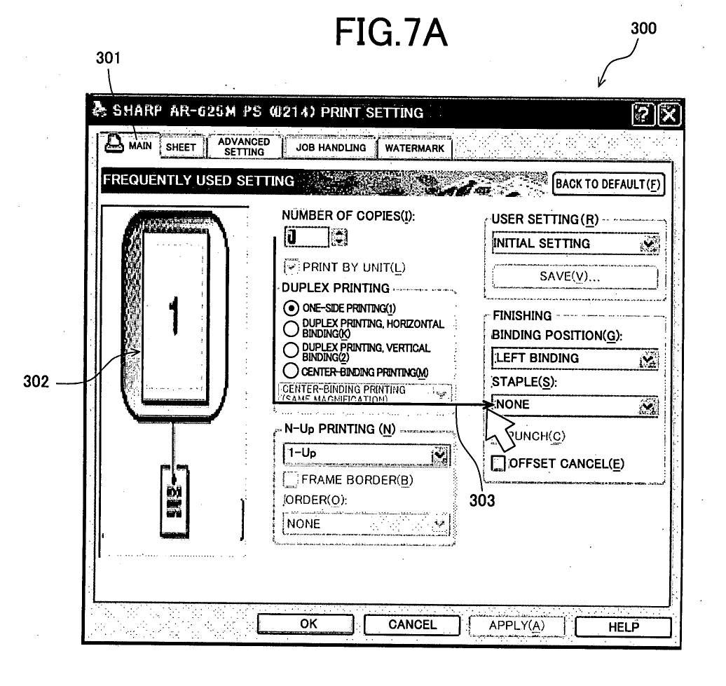

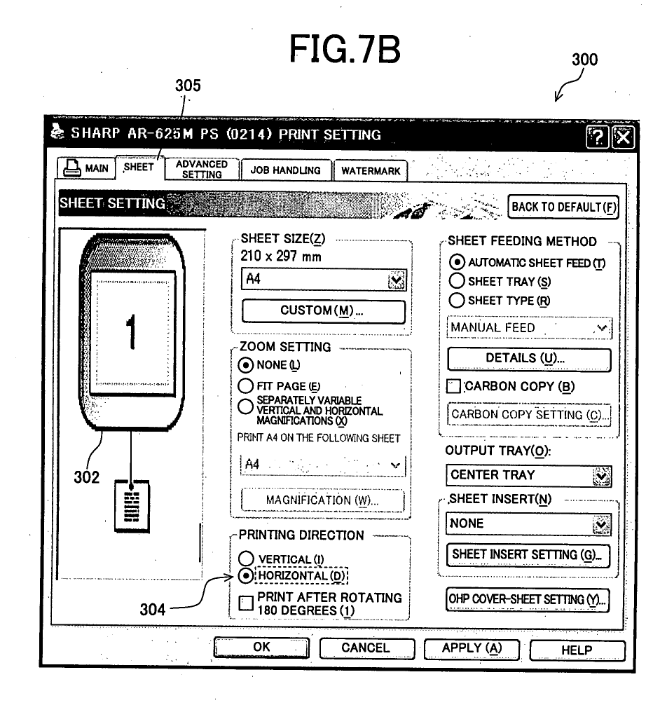

FIG. 7A and FIG. 7B are views for describing an example of the gesture operations in a print setting screen, and FIG. 7A shows an example of the pointer operation on the print setting screen and FIG. 7B shows an example of the display screen after the pointer operation.

In the present invention, a user can set information processing conditions by operating a pointer on a screen with a pointing device, and the example of FIG. 7A and FIG. 7B shows a processing example in the case that the information processing system acts as a printer driver and that the pointer is operated on the print setting screen which is a user interface screen at that time.

The print setting screen 300 of FIG. 7A is a user interface screen for setting print processing conditions and can set various processing conditions relevant to the print processing. The example of FIG. 7A shows a main tab 301 which displays print image information 302 representing a print image. In the print image information 302, the direction and layout of the print page can be visually checked, and although the print data itself are not displayed, the print image information 302 may be displayed as a preview screen by additionally including the print image data or may be displayed as a thumbnail image. The print image information 302 is defined here as including the preview screen and the thumbnail image.

The user operates a pointer displayed on the screen of FIG. 7A with the use of a pointing device, such as a mouse. In this example, the pointer operation can be performed at any position on the screen.

In the example of FIG. 7A, the pointer trace 303 indicates the predetermined operation for setting a horizontal sheet direction as shown in FIG. 5I. The graphical user interface processing unit 202 of the information processing system determines that the pointer operation is the horizontal sheet setting and sets the sheet direction to be horizontal in the print processing conditions.

FIG. 7B shows that the condition relevant to the sheet direction has been set correspondingly to the pointer operation of FIG. 7A, and in a sheet tab 305 screen, a print direction 304 has been set to be horizontal. At this point, the screen can be automatically changed from FIG. 7A to the condition setting screen of FIG. 7B such that the user can check contents of the setting. In other words, at this point, the user can set processing conditions which are not displayed on the same screen and can check the setting status even if the setting is changed for the processing conditions which are not displayed in the same screen information.

In this way, the user can easily set the processing conditions corresponding to the predetermined operations by performing the predetermined pointer operations at any position on the print setting screen.

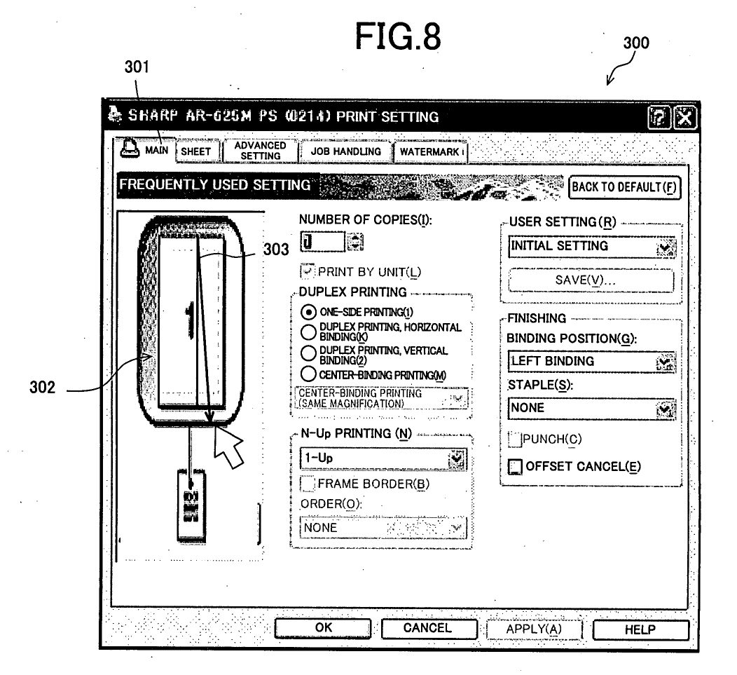

FIG. 8 is a view for describing another example of the gesture operation in the print setting screen.

The operation of the pointer on the above print setting screen may be defined such that the pointer gesture operation is performed within the display area of the print image information 302 representing the print image as described above. Therefore, in this case, the user can set the print processing conditions by performing the pointer gesture operation within the display area of the print image information 302 displayed on the main tab 301 of the print setting screen 300.

In the example of FIG. 8, the pointer trace 303 indicates the predetermined operation for setting the duplex vertical binding as shown in FIG. 5A. The graphical user interface processing unit 202 of the information processing system determines that the pointer operation is the duplex vertical binding setting and sets the print processing condition as the duplex vertical binding.

By operating the pointer within the display area of the print image information 302, the user can conveniently perform intended operations intuitively depending on how the predetermined operations are set. For example, in the case that the processing setting for punching or stapling of a print sheet is performed by the gesture operation, if the gesture operation is performed in the vicinity of the place to be punched or stapled within the display area of the print image information 302, the user can easily understand and set the processing condition. In other words, operations performed by specifying a position of the print image are effectively performed by the pointer gesture operation within the display area of the print image information 302 like the present example.

The programs achieving functions relevant to the above embodiments are, for example, stored in a recording medium such as a CD-ROM in advance, and the functions of the present invention can be achieved by loading the recording medium into a medium drive apparatus such as a CD-ROM drive provided in a computer and the like and by storing the programs into a memory or a recording apparatus of the computer for execution. In this case, the functions of the embodiments described above are achieved by the programs itself read out from the recording medium, and the programs and the recording medium recording the programs also constitute the present invention.

The recording medium storing the programs may be any of a semiconductor medium (e.g., a ROM, nonvolatile memory card and others), an optical recording medium (e.g., a DVD, MO, MD, CD and others), a magnetic recording medium (e.g., a magnetic tape, flexible disk and others) and the like.

Not only the functions of the embodiments described above are achieved by executing the loaded program, but also the functions of the embodiments described above may be achieved by performing processing in conjunction with an operating system or other application programs based on instructions from the program.

When distributing to the market, the programs can be stored into a portable recording medium for distribution or can be transferred to server computers connected via network, such as the internet. In this case, the recording medium of the present invention includes a storage apparatus of the server computer.

In a computer, the functions of the embodiments described above are achieved by installing the programs on the portable recording medium or the transferred programs into the storage medium connected to the computer and by executing the installed programs.

According to the present invention, advantages can be obtained as follows.

According to the present invention, when the pointer gesture operation corresponds to the predetermined operation retained in advance, the setting is performed for the processing condition defined in advance correspondingly to the corresponding predetermined operation, and thereby the user can easily set the processing condition by only performing a simple operation of a pointing device such as a mouse.

Also, the present invention can set processing conditions which are not displayed on the same screen, and since the setting status can be checked even if the setting is changed for the processing conditions which are currently not displayed in the same screen information, the user can enjoy great convenience.

Also, since a plurality of the processing conditions can be set by combining various pointer operations, a plurality of the processing conditions can be easily set by the simple pointer operation.

1. An information processing system enabling connection between display means and a pointing device which can operate a pointer displayed on the display means, generating a user interface screen for setting a plurality of processing conditions relevant to information processing and displaying the user interface screen on the display means, and enabling a pointer displayed on the user interface screen to be operated by the pointing device,
wherein when a gesture operation operating the pointer being dragged is performed and when the gesture operation corresponds to a predetermined operation retained in advance, the information processing system sets the processing condition defined in advance correspondingly to the corresponding predetermined operation.

2. The information processing system of claim 1, wherein the information processing system comprises: UI display means which generate a user interface to be displayed on the display means; a gesture operation information retaining means which retain setting information of processing conditions corresponding to the gesture operations of the pointer in advance; pointer operation detecting means which detect the gesture operations of the pointer displayed on the user interface screen; gesture operation determining means which refer to the gesture operation information retaining means according to the detection result of the pointer operation detecting means to determine setting information corresponding to the pointer gesture operation; processing condition setting means which set processing conditions according to the determination result of the gesture operation determining means; and setting information storage means which store the setting information of the processing conditions set by the processing condition setting means.

3. The information processing system of claim 1 or 2, wherein the predetermined operation of the pointer comprises any one or more of motions of the pointer, which include movement in the upward, downward, leftward and rightward directions, diagonal movement, circle or circular arc movement, and stoppage for a predetermined time period.

4. The information processing system of claim 1 or 2, wherein the setting can be performed for the processing condition corresponding to the predetermined operation of the pointer even if the processing condition to be set is not displayed on the user interface screen.

5. The information processing system of claim 4, wherein if the setting corresponding to the predetermined operation is performed for the processing condition which is not displayed on the user interface screen, contents of the set processing condition are displayed on the user interface screen.

6. The information processing system of claim 1 or 2, wherein the information processing system is an information processing system which comprises a print data processing unit executing print data processing for performing print control of a printing apparatus connected to the information processing system and which acts as a printer driver controlling the printing apparatus with the use of the processing result of the print data processing unit, and wherein processing conditions of the information processing are conditions relevant to setting of print processing.

7. The information processing system of claim 6, wherein print image information representing a print image is displayed on the user interface screen and wherein when the predetermined operation of the pointer is performed within the display area of the print image information, setting is performed for the processing condition defined in advance correspondingly to the predetermined operation.

8. The information processing system of claim 1 or 2, wherein a processing condition set by the predetermined operation can be restored to the processing condition before the setting by the operation of the pointing device or other input means.

9. A program operable to allow a computer to act as the information processing system of claim 1.

10. A computer-readable recording medium having thereon recorded the information processing program of claim 9.
